(19) United States
(12) Patent Application Publication
(10) Pub. No.: US 2005/0103891 A1
(43) Pub. Date: May 19, 2005

(54) Fluid product dispenser

(75) Inventors: Aline Abergel, Boulogne-Billancourt (FR); Gerard Cornet, Blaru (FR); Firmin Garcia, Evreux (FR)

Correspondence Address: SUGHRUE MION, PLLC, 2100 PENNSYLVANIA AVENUE, N.W., SUITE 800, WASHINGTON, DC, 20037, US

(73) Assignee: VALOIS S.A.S., LE NEUBOURG (FR)

(21) Appl. No.: 10/497,640

(22) PCT Filed: Dec. 2, 2002
(86) PCT No.: PCT/FR02/04131

(30) Foreign Application Priority Data
Dec. 4, 2001 (FR) 01 15657

(51) Int. Cl. B05B 9/043

(52) U.S. Cl. 239/333

(57) ABSTRACT

A fluid dispenser comprising a fluid reservoir (2), a dispenser member (3; 13), and a dispenser outlet (31; 131) through which fluid is dispensed in the form of a dispensing spray intended to be directed towards a target, the dispenser being characterized in that it is provided with adjustment means (4; 51; 52; 53; 54; 144, 146; 1310) that are capable of modifying at least one characteristic of the dispensing spray.

The present invention relates to a fluid dispenser comprising a reservoir designed to contain a fluid, a dispenser member, and a dispenser outlet through which the fluid is dispensed in the form of a dispensing spray normally intended to be directed towards or onto a target. The fluid reservoir can be in the form of a flask, a bottle, or even a flexible deformable pouch. The dispenser member can be a manual pump or valve, but preferably, the present invention applies to dispenser members that make it possible to deliver a dispensing spray that is continuous or that is at least of visually continuous appearance. To do this, dispenser devices can be used that make use of an optionally-perforated vibrator membrane that is driven by means of a vibrator element such as a piezoelectric element, or even by means of a high-rate drive system using an electromagnet, for example. With regard to the dispenser outlet, it can be in the form of a simple dispenser orifice, or even in the form of a plurality of holes forming a dispenser array.

As mentioned above, an electromechanical dispenser member makes it possible to obtain a dispensing spray that is continuous, or that is made up of consecutive sprays that are so close together in time that the human eye perceives said succession of sprays in the form of a continuous dispensing spray. Numerous fluid dispensers already exist that make it possible to obtain such a continuous or pseudo-continuous dispensing spray. By way of example, document EP-0 615 470 can be cited, in which the dispenser member uses a perforated vibrator membrane that is advantageously driven by a piezoelectric element. In another document, WO 01/34307, the dispenser member functions by means of a vibrator element, e.g. an electromagnet, which drives a vibrator membrane forming a movable portion of a dispenser chamber containing the fluid.

However, with such prior-art fluid dispensers, actuation of the dispenser enables a perfectly-even pseudo-continuous dispensing spray to be generated, regardless of the type of target that is involved.

An object of the present invention is to remedy the above-mentioned prior-art drawback by providing adjustment means that are capable of modifying at least one characteristic of the dispensing spray. The term “characteristic” of the dispensing spray refers mainly to the shape of the dispensing spray, or else to the flowrate of the dispensing spray. The dispensing spray may be wider or more concentrated or it may be shorter or longer. In addition, the quantity of fluid discharged per second or per minute can be smaller or greater. Consequently, these two characteristics seem to be sufficient to characterize a given dispensing spray.

In the invention, the adjustment means may also be capable of modifying the actuating frequency of the dispenser member. Naturally, adjusting the actuating frequency makes it possible either to modify the flowrate of the dispensing spray, or to modify the shape of the dispensing spray, or both at the same time.

In a first embodiment, the dispenser outlet comprises a plate that is perforated with an array of dispenser holes through which the fluid is dispensed in the form of individual sprays, said sprays together forming the dispensing spray, the adjustment means including deformation means that are capable of deforming the perforated plate, at least at the array of dispenser holes, thereby varying the directions of the holes relative to each other. In this case, the deformation means may comprise a stress-applying system including a fixed support zone on which the perforated plate rests, and a movable element that is designed to stress the plate over the support zone, so that it deforms into a curved shape. In a variant, the deformation means may comprise a piezoelectric element that is fixed to the perforated plate and that is designed to be powered in such a manner as to induce stable deformation of the plate. By deforming the plate in this way, the holes of the array of dispenser holes take on various directions, thereby widening or narrowing the dispensing spray. It is easily understood that by causing the perforated plate to bulge in convex manner, the dispensing spray becomes wider, while by causing it to bulge in concave manner, the spray becomes more concentrated.

In another embodiment which can be implemented individually or in combination with the preceding embodiment, a supply duct connects the reservoir to the dispenser outlet, the adjustment means include restriction means that are capable of modifying the flow section of the supply duct. The restriction means advantageously include a presser member that is capable of elastically deforming the supply duct.

In another embodiment enabling the shape of the dispensing spray to be modified, the dispenser outlet comprises a plate that is perforated with an array of dispenser holes through which the fluid is dispensed in the form of individual sprays, said sprays together forming the dispensing spray, the adjustment means including a diaphragm system that is capable of covering a selected portion of the dispensing holes. By covering a portion of the dispenser holes in this way, not only is the flowrate of the dispensing spray modified, but also the shape of the spray. This embodiment therefore makes it possible to influence simultaneously both the shape and the flowrate of the spray.

In still another embodiment of the invention, the dispenser member includes a pump chamber provided with a movable wall that is driven back and forth at a high rate by a drive element that is driven in rapid back and forth motion between a driven-in position in which the pump chamber defines a minimum volume, and a withdrawn position in which the element comes into contact with an end-of-stroke abutment, the adjustment means including spring means that are associated with the end-of-stroke abutment, so as to enable the abutment to be displaced against the force of the spring means when the actuator element comes into contact with the abutment.

Variation means are advantageously provided that are capable of modifying the force of the spring means.

In still another aspect of the invention, the dispenser member includes an outlet valve formed by a movable valve member that is urged to press in leaktight manner against a valve seat by resilient means, the adjustment means being capable of varying the force with which the resilient means urge the movable valve member against its seat. It is thus possible to harden or soften the contact of the movable valve member against its seat, thereby modifying the flowrate passing through the outlet valve. In response, not only can the dispensing spray be caused to present a slower flowrate, but it has also been observed empirically that the shape of the dispensing spray is also affected. The same applies when varying the amplitude of the drive element which displaces the movable wall back and forth. The flowrate and the shape of the spray are modified.

According to another characteristic which can be implemented in all of the preceding embodiments, the dispenser includes detection means that are capable of detecting at least one physical characteristic of the target onto which the fluid is to be dispensed, said detector, after detecting said characteristic of the target, activating the adjustment means in order to adapt the dispensing spray to the desired target. In this way, the user need only aim at the desired target: the detection means detect the characteristic of the desired target, and the adjustment means modify the dispensing spray as a function of the value detected by the detection means. Naturally, the dispenser may be moved towards the target, but it is also possible to envisage moving the target towards a fixed dispenser.

The invention is described more fully below with reference to the accompanying drawings which show several embodiments of the invention by way of non-limiting example.

In the figures:

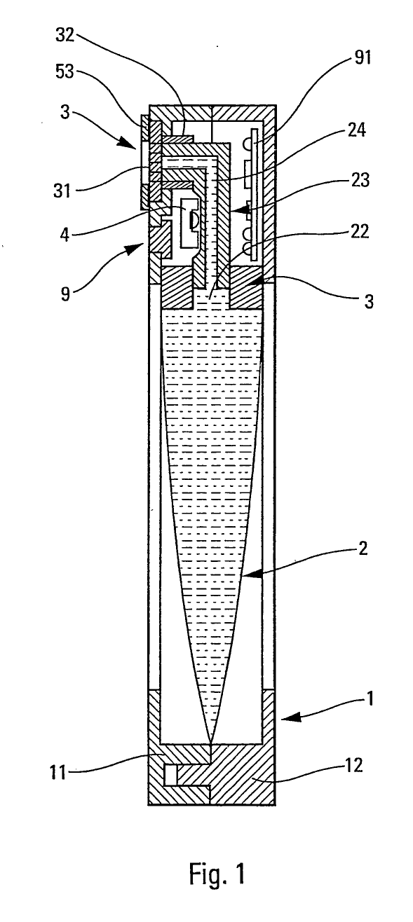

FIG. 1 is a vertical section view through a fluid dispenser constituting a first embodiment of the invention;

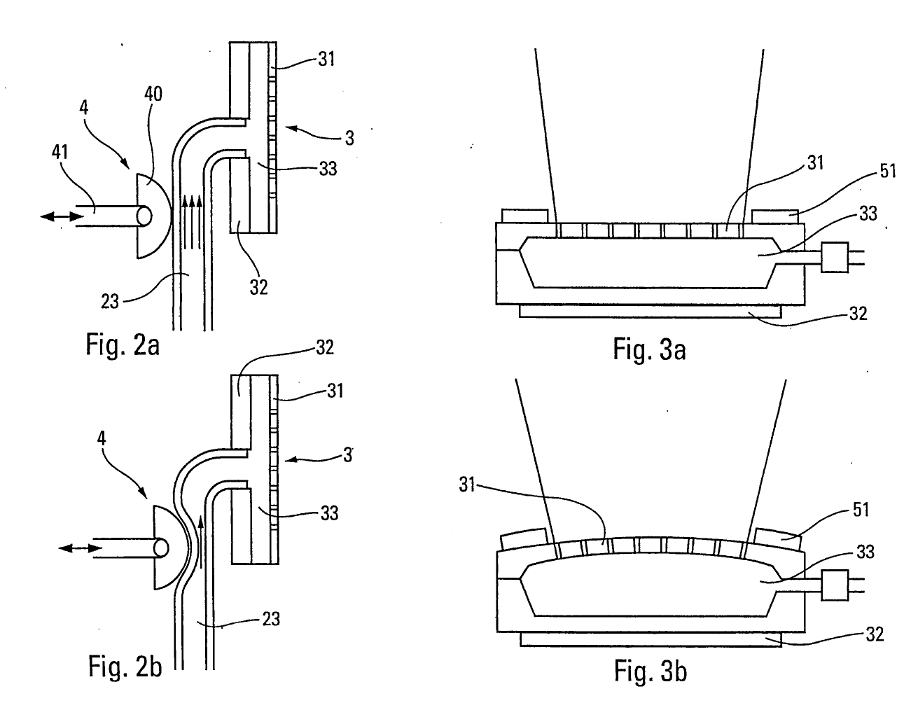

FIGS. 2a and 2b show a flowrate variation system of the same type as that incorporated in the dispenser of FIG. 1;

FIGS. 3a and 3b show a system for varying the angle of the dispensing spray, the system constituting a first embodiment;

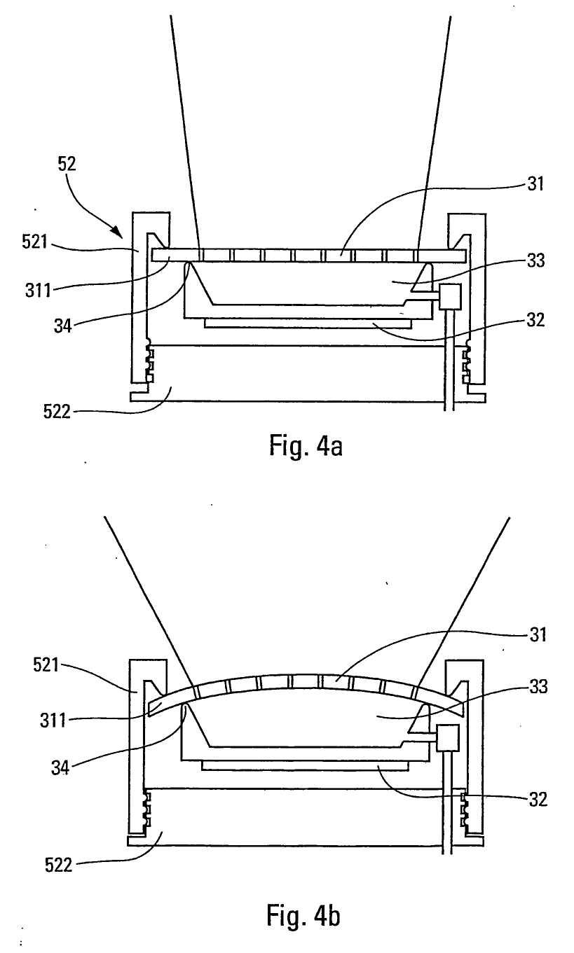

FIGS. 4a and 4b show a variant embodiment of a system for varying the angle of the dispensing spray;

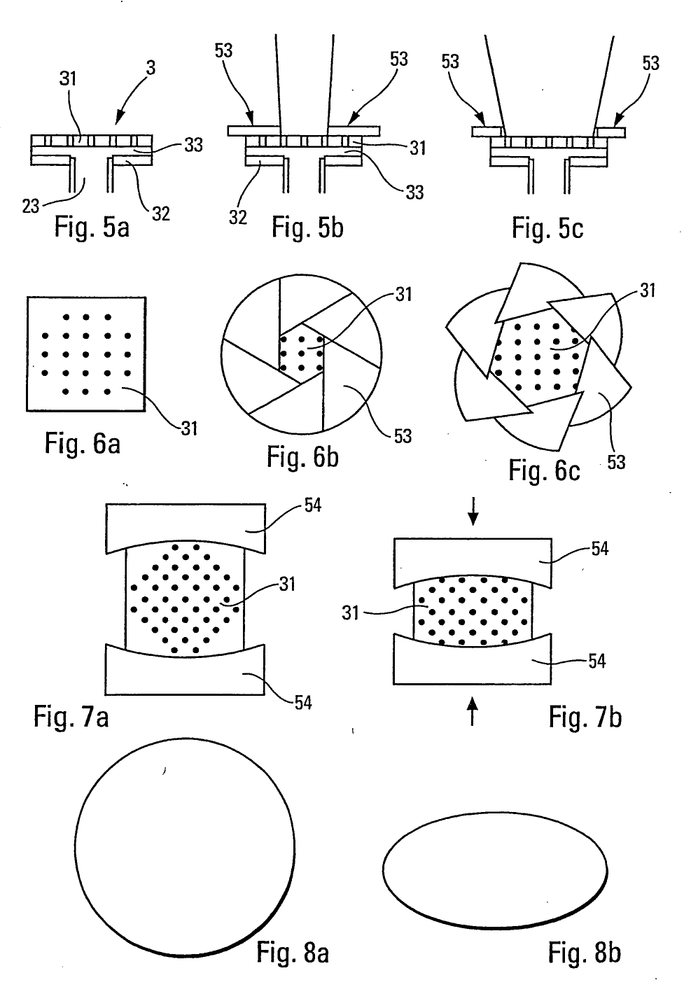

FIGS. 5a, 5b, and 5c are cross section views through a dispenser member having a perforated membrane and a piezoelectric element equipped with a system for varying the flowrate and the angle of the dispensing spray, in a first embodiment;

FIGS. 6a, 6b, and 6c are plan views of FIGS. 5a, 5b, and 5c respectively;

FIGS. 7a and 7b show a variant of a system for varying the flowrate and the angle of the dispensing spray;

FIGS. 8a and 8b show the zone of impact on a target for the systems shown in FIGS. 7a and 7b respectively;

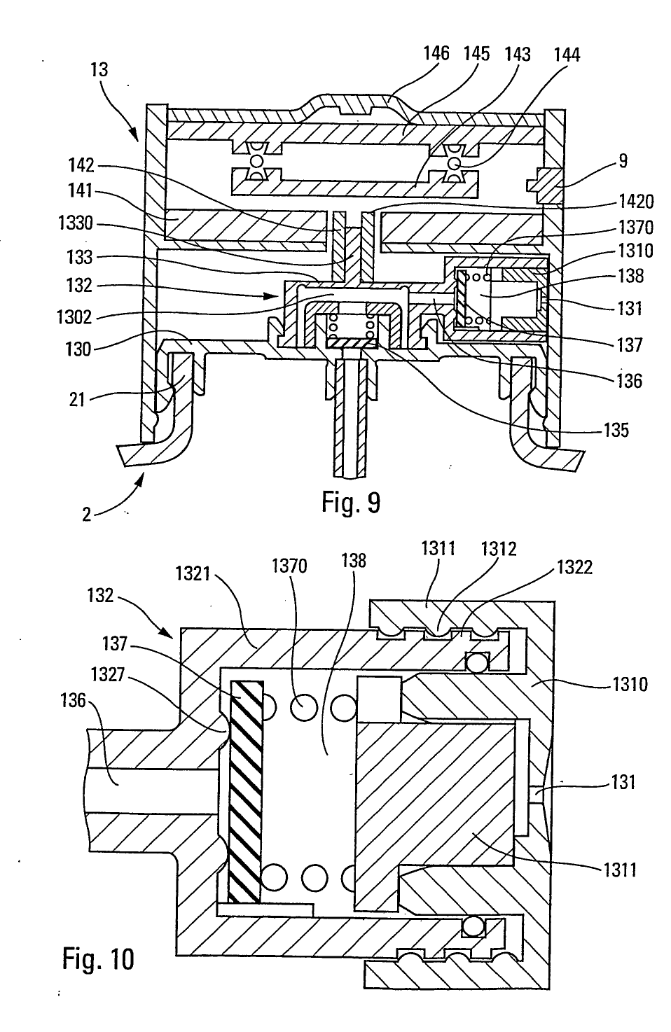

FIG. 9 is a vertical section view through a fluid dispenser constituting a second embodiment; and

FIG. 10 is a larger-scale section view of a portion of the dispenser of FIG. 9.

In the first embodiment shown in FIG. 1, the fluid dispenser is a dispenser in the form of a portable manual spray that the user can hold in one hand. The dispenser comprises a reservoir in the form of a flexible pouch 2 fixed on a support part 21 defining an opening 22. A supply duct connects the opening 22 to a dispenser member, which, in this case, is in the form of a perforated plate 31 associated with a vibrator element 32, which can be a piezoelectric element. The perforated plate 31 is pierced with an array of dispenser holes which together define the dispenser outlet of the dispenser. The supply duct 23 can advantageously contain a capillary wick 24 which enables the perforated vibrator plate 31 to be supplied with fluid from the opening 22 of the flexible pouch 2.

The flexible pouch 2 with its support part 21 can be received in a rigid shell 1 formed of two connected-together shell halves 11 and 12.

The dispenser can be fitted with an actuator button enabling the vibrator element 32 to be electrically powered by one or more batteries (not shown). Advantageously, an integrated circuit 91 can be provided in order to control the vibrator element 32. Thus, by pressing on the actuator button (not shown), the vibrator element excited in this way causes the perforated plate 31 to vibrate, thereby generating a continuous dispensing spray through the array of dispenser holes. In reality, the dispensing spray is not, in fact, continuous, but the dispensing jets are so close that the dispensing spray seems to be continuous to the human eye. The dispensing spray is thus referred to as being pseudo-continuous.

In the invention, the delivery rate of the duct 23 which enables the reservoir 2 to communicate with the perforated plate 31 can be modified by a flowrate variation system 4. By way of example, the flowrate variation system 4 can act on a flexible portion of the supply duct 23 in such a manner as to reduce its flow section locally. This is also visible in FIGS. 2a and 2b which show a variant embodiment of the actuator member 3. In this case, the advantageously-piezoelectric vibrator element 32 is not connected to the perforated plate 31, but instead, a fluid chamber 33 extends between the vibrator element 32 and the perforated plate 31, so that the vibrator element 32 communicates the vibration to the fluid which is then expelled through the array of dispenser holes of the perforated plate 31. It is, however, possible to see a flowrate variation system 4, which, in this case, is in the form of a presser wheel 40 that is urged by a spring 41 with variable force. In FIG. 2a, the wheel 40 does not press against the supply duct 23, whereas in FIG. 2b, the wheel significantly deforms the duct 23 in such a manner as to reduce its flow section locally. Thus, the chamber 33 (in the case of FIGS. 2a and 2b), or the perforated plate 31 directly (in the case of FIG. 1), is supplied with a smaller quantity of fluid, so that the flowrate of the dispensing spray is reduced. This reduction in the flowrate also has an effect on the shape of the dispensing spray, making it rather more concentrated. As a result, it can be said that the flowrate variation means 4 make it possible to adjust or to modify the characteristics of the dispensing spray, in this case its flowrate and its shape. By way of example, the flowrate variation means 4 can be adjusted by means of a button or by a knob that the user turns, thereby setting the dispensing spray at a determined flowrate.

In the invention, a diaphragm system 53 or 54 can also be provided, which is shown diagrammatically in FIG. 1, but which is more visible in FIGS. 5b, 5c, 6b, 6c, and 7a, 7b. The diaphragm system 53, 54 can be placed on the outside of the perforated plate 31 so as to be able to cover a selected portion of the dispenser holes of the array formed in the perforated plate 31. The diaphragm system can be in the form of several shutters, as is the case for system 53, or can more simply be in the form of two shutters sliding towards or away from each other, as is the case for system 54 in FIGS. 7a and 7b. In both cases, the diaphragm systems 53 and 54 in the positions in FIGS. 6b and 7b respectively, make it possible significantly to reduce the number of dispenser holes through which the fluid can be dispensed. With the diaphragm system 53, it is possible to reduce or to increase the diameter of the dispenser spray at the perforated plate 31. Furthermore, a reduction in the diameter causes the angle of the spray to be reduced, as can be seen in FIGS. 5b and 5c. With the diaphragm system 54 in FIGS. 7a and 7b, the shape of the spray can be modified in such a manner as to obtain an oval impact on the target, as can be seen in FIG. 8b, while in the case in FIG. 7a, in which the diaphragm system 54 is inoperative, the impact on the target is circular, as can be seen in FIG. 8a. The diaphragm system 53 or 54 makes it possible not only to vary the flowrate of the dispensing spray, but also makes it possible to modify the shape of the spray both at its base on the perforated plate 31, and in terms of its dispensing angle. As with all of the flowrate variation means 4, the diaphragm system 53 or 54 can be actuated by means of a knob or by a slider present on the housing of the dispenser.

In another aspect of the invention, it is also possible to vary the angle of the dispensing spray without varying its flowrate. This is possible by means of a deformation system for deforming the perforated membrane in such a manner that said membrane becomes curved, thereby modifying the directions of the dispenser holes relative to one another.

In the embodiment in FIGS. 3a and 3b, the actuator member comprises a perforated plate 31 forming an array of dispenser holes, a fluid chamber 33, and a vibrator element. The vibrator element 32 transmits vibration to the fluid present in the dispenser chamber 33, thereby causing the fluid to be expelled through the dispenser holes of the perforated plate 31. In the invention, a second constriction element 51, e.g. a piezoelectric element, is associated with the perforated plate 31. The constriction element 51, when suitably powered, e.g. with DC, deforms the perforated plate 31 in such a manner that said plate becomes curved, as can be seen in FIG. 3b. In this way, it can be seen immediately that the extreme dispenser holes define dispensing angles that are much greater than the angle in FIG. 3a. In this way, it is possible to increase the diameter of the spray at the target. It should be noted that this takes place without any change in the flowrate.

In the second embodiment in FIGS. 4a and 4b, the curve of the perforated plate 31 is obtained mechanically by means of a stress-applying system 52 which can be in the form of a bushing 521 which is engaged on the periphery of the perforated plate 31. Furthermore, the perforated plate 31 is supported at 34. By displacing the bushing 521 relative to a base, e.g. a threaded base 522, the peripheral edge 311 of the perforated plate 31 is stressed downwards, as shown in FIG. 4b. In response, the perforated plate 31 curves or bulges, thereby increasing the dispensing angle. Displacement of the bushing 521 can be adjusted by means of a knob or a slider present on the housing of the dispenser. The power applied to the constriction element 51 can also be adjusted by means of a knob present on the housing.

In another aspect of the invention, the dispenser can also include detection means which are in the form of a detection cell 9 associated with a control circuit which can be integrated in the circuit 91. The detection cell 9 is designed to detect a physical characteristic of the target onto which the dispensing spray is intended to be directed. This characteristic value can be the distance between the cell and the target, the wetness of the target, the brightness of the target, the content of a certain substance in the target, etc. Thus, it is even possible to omit any adjustment button, knob, or slider as mentioned above. After detecting the desired physical value, the detection cell 9 delivers a message to the circuit 91 which sends it a triggering or adjustment signal in order to trigger or adjust the above-mentioned adjustment means in such a manner as to vary the flowrate or the shape of the dispensing spray. The use of detection means 9 can also be combined with an actuator button. In this case, the detection means serve to preset the adjustment means, but actual actuation is triggered only by pressing on the actuator button.

A second embodiment of a fluid dispenser of the invention is described below, with reference to FIG. 9. In this second embodiment, the dispenser member 13 is mounted directly on a neck 21 of a reservoir 2 which can be in the form of a bottle or a rigid flask. The dispenser member includes a body 130 fixed onto the neck 21. By way of example, the body 130 further defines an inlet which communicates with the reservoir 2 by means of a plunger-tube. By way of example, the inlet is fitted with an inlet valve 135 that is urged by means of a spring against a seat formed on the body 130. A chamber piece 132 is mounted on the body 130 in such a manner as to define a pump chamber 1302 therebetween. The chamber piece 32 includes a deformable wall 133 which is thus in the form of a membrane. The membrane 133 forms a handle appendage 1330 which is associated with a ferromagnetic sleeve 142. As well as the chamber 1302, the chamber piece 132 also forms an outlet duct 136 which leads to an outlet-valve chamber 138 closed at an inlet end by a moving valve member 137 that is urged against a seat 1327 by a spring 1370. At the other end, the chamber is closed in part by a bushing 1310 which forms a dispenser orifice 131.

In order to cause the ferromagnetic sleeve 142 to move back and forth at a high rate, an electromagnet 141 is provided which has a central opening through which the ferromagnetic sleeve 142 extends. By powering the electromagnet 141 with AC, the sleeve 142 is moved back and forth in the opening of the electromagnet 142, entraining the membrane 133 which forms a movable wall of the pump chamber 1302.

In the invention, the ferromagnetic sleeve 142 has a free end 1420 designed to come into abutment against an end-of-stroke abutment 143. The end-of-stroke abutment 143 is mounted on spring means 144 which bear on a fixed plate 145 having a height that can be adjusted by means of an adjustment cap. It is thus possible to adjust the stiffness or the hardness of the spring 144 in order to harden or soften the force with which the sleeve 142 presses against the end-of-stroke abutment 143. It is thus possible to vary the height of the stroke of the ferromagnetic sleeve 142 by varying the stiffness of the spring means 144. Furthermore, it is possible to increase or to reduce the power fed to the electromagnet 141 in such a manner as to reduce or to increase the displacement of the membrane 133. By acting on the adjustment cap 146, it is thus possible to vary the stroke of the sleeve 142 and thus the displacement of the membrane 133. This has an effect on the frequency and/or amplitude of displacement of the membrane 133, thereby varying the flowrate of fluid dispensed by the pump chamber 1302.

It is also possible to vary the flowrate of the dispensing spray at the outlet 131 by hardening or by softening the force of the spring 1370 which urges the movable valve member 137 against its seat 1327, as can be seen in FIG. 10. In order to modify the force of the spring, provision is made for the bushing 1310 to be mounted in threaded manner on the cylinder 1321 forming a portion of the valve chamber 138. Given that the spring 1370 bears against a core 1311 secured to the bushing 1310, displacement of said bushing has the effect of relaxing or of compressing the spring 1370 and thus hardening the contact of the movable valve member against its seat 1327. Thus, the opening threshold of the outlet valve is modified, thereby varying the flowrate of the fluid at the dispenser orifice 131. It has been observed empirically that this not only has an effect on the dispensing flowrate, but also on the shape of the dispensing spray.

It is thus possible to modify one or more characteristics of the dispenser spray by acting either on the power fed to the electromagnet 141, or on the adjustment cap 146, or on the bushing 1310. It is also possible to combine such adjustments.

As in the preceding embodiment in FIG. 1, the dispenser includes detection means 9 designed to detect a physical characteristic of the intended target, as is the case in the preceding embodiment. The detection means can serve as triggering means or even as presetting means acting on the adjustment means of the dispenser spray.

By means of the invention, the flowrate and the shape of the dispensing spray can be adjusted, either manually, or by means of a detection cell of the target.

1. A fluid dispenser comprising a fluid reservoir (2), a dispenser member (3; 13), and a dispenser outlet (31; 131) through which fluid is dispensed in the form of a dispensing spray intended to be directed towards a target, the dispenser being characterized in that it is provided with adjustment means (4; 51; 52; 53; 54; 144, 146; 1310) that are capable of modifying at least one characteristic of the dispensing spray.

2. A dispenser according to claim 1, in which the dispensing spray is continuous or of visually continuous appearance.

3. A dispenser according to claim 1, in which the adjustment means (51; 52; 53; 54) are capable of modifying the shape of the dispensing spray.

4. A dispenser according to claim 1, in which the adjustment means (4; 144, 146; 1310) are capable of modifying the flowrate of the dispensing spray.

5. A dispenser according to claim 1, in which the adjustment means are capable of modifying the actuating frequency of the dispenser member.

6. A dispenser according to claim 3, in which the dispenser outlet comprises a plate (31) that is perforated with an array of dispenser holes through which the fluid is dispensed in the form of individual sprays, said sprays together forming the dispensing spray, the adjustment means (51, 52) including deformation means that are capable of deforming the perforated plate, at least at the array of dispenser holes, thereby varying the directions of the holes relative to each other.

7. A dispenser according to claim 6, in which the deformation means comprise a stress-applying system (52) including a fixed support zone (34) on which the perforated plate (31) rests, and a movable element (521) that is designed to stress the plate over the support zone, so that it deforms into a curved shape.

8. A dispenser according to claim 6, in which the deformation means comprise a piezoelectric element (51) that is fixed to the perforated plate (31) and that is designed to be powered in such a manner as to induce stable deformation of the plate.

9. A dispenser according to claim 4, in which a supply duct (23) connects the reservoir (2) to the dispenser outlet, the adjustment means include restriction means (4) that are capable of modifying the flow section of the supply duct.

10. A dispenser according to claim 9, in which the restriction means (4) include a presser member (40) that is capable of elastically deforming the supply duct (23).

11. A dispenser according to claim 3, in which the dispenser outlet comprises a plate (31) that is perforated with an array of dispenser holes through which the fluid is dispensed in the form of individual sprays, said sprays together forming the dispensing spray, the adjustment means including a diaphragm system (53; 54) that is capable of selectively covering a portion of the dispensing holes.

12. A dispenser according to claim 3, in which the dispenser member includes a pump chamber (1302) provided with a movable wall (133) that is driven back and forth at a high rate by a drive element (142) that is driven in rapid back and forth motion between a driven-in position in which the pump chamber defines a minimum volume, and a withdrawn position in which the element comes into contact with an end-of-stroke abutment (143), the adjustment means including spring means (144) that are associated with the end-of-stroke abutment, so as to enable the abutment to be displaced against the force of the spring means when the actuator element comes into contact with the abutment.

13. A dispenser according to claim 12, in which variation means (146) are provided that are capable of modifying the force of the spring means (144).

14. A dispenser according to claim 3, in which the dispenser member includes an outlet valve (137, 1327) formed by a movable valve member (137) that is urged to press in leaktight manner against a valve seat (1327) by resilient means (1370), the adjustment means (1310) being capable of varying the force with which the resilient means urge the movable valve member against its seat.

15. A dispenser according to claim 1, including detection means (9) that are capable of detecting at least one physical characteristic of the target onto which the fluid is to be dispensed, said detector, after detecting said characteristic of the target, activating the adjustment means in order to adapt the dispensing spray to the desired target.
